(19) United States
(12) Patent Application Publication
(10) Pub. No.: US 2023/0306005 A1
(43) Pub. Date: Sep. 28, 2023

(54) SYSTEM AND METHOD FOR PROTECTING DATA IN A BACK-UP APPLIANCE USING SHALLOW METADATA COPYING

(71) Applicant: QUANTUM CORPORATION, San Jose, CA (US)

(72) Inventors: Peter Jackson, Salisbury East (AU); Adam Hawes, Mount Barker (AU)

(21) Appl. No.: 18/125,047

(22) Filed: Mar. 22, 2023

Related U.S. Application Data
(60) Provisional application No. 63/323,729, filed on Mar. 25, 2022.

(51) Int. Cl. G06F 16/215; G06F 16/2457

(52) U.S. Cl. CPC G06F 16/215; G06F 16/24573

(57) ABSTRACT

A method for protecting data within a storage system includes receiving one or more user objects from a user into the storage system, the user objects including user data that includes user metadata and raw data; deduplicating the raw data; copying the user metadata and system metadata to provide copied metadata; and storing the copied metadata in a metadata storage area within the storage system so that the copied metadata stored in the metadata storage area is not modifiable by the user. The method can further include storing the copied metadata in a separate, second metadata storage area within the storage system that is user modifiable. At least a portion of the copied metadata stored in the user modifiable metadata storage area and copied to the unmodifiable metadata storage area includes a reference that points to sub-objects in the data storage area that allows the system to rehydrate the raw data for the user objects.

### RELATED APPLICATION

This application claims priority on U.S. Provisional Application Ser. No. 63/323,729 filed on Mar. 25, 2022 and entitled “SYSTEM AND METHOD FOR PROTECTING DATA IN A BACK-UP APPLIANCE USING SHALLOW METADATA COPYING”. As far as permitted, the contents of U.S. Provisional Application Ser. No. 63/323,729 are incorporated in their entirety herein by reference.

### BACKGROUND

Network storage systems, or network-attached storage (NAS), are configured to allow multiple network users to access the data saved within the network storage system. More specifically, NAS is a file-level computer data storage server that is connected to a computer network for providing data access to a heterogeneous group of customers or users. NAS is specialized for serving files either by its hardware, software, or configuration. It is often manufactured as a computer appliance, such as a purpose-built specialized computer. NAS systems are networked appliances that contain one or more storage drives, often arranged into logical, redundant storage containers. NAS removes the responsibility of file serving from other servers on the network. Since the mid-1990s, NAS devices have gained popularity as a convenient method of sharing files among multiple computers. Potential benefits of dedicated network-attached storage, compared to general-purpose servers also serving files, include faster data access, easier administration, and simple configuration.

Unfortunately, with any network-attached storage, malicious actors could delete, corrupt, encrypt, or otherwise render the data unusable, via the same storage services that legitimate users invoke to manipulate the data. Also, in some situations, legitimate users can accidentally delete or otherwise corrupt any given data set to which they may have access. Thus, it is desired to protect the data so that the data cannot be deleted, corrupted, encrypted or otherwise rendered unusable.

Existing approaches for protecting the data in network storage systems include generating off-site copies, saving full data copies in hidden directory locations, placing time-locks on the original data, and utilizing write-once-read-many (WORM) techniques.

However, such approaches have not been altogether satisfactory. For example, some approaches require considerable additional data storage capacity and necessarily require an amount of time to copy data elsewhere before it is protected. This overhead may be considerable if the customer is injecting massive amounts of data into the system. An automated expiration system is required to ensure that the copy dataset does not fill up. An attacker who is intent on destroying data may abuse these features to cause good copies to be expired and replaced with data they already corrupted.

Additionally, time-locks and WORM prevent the user from modifying their own data until the lock period expires. The file system can approach this by allowing the user to set a future modification time (mtime) on an inode before making the inode immutable (unchangeable over time). It is then essentially impossible for any user, including the administrator, to remove the immutable flag until the system clock passes that future time. This may be an undesirable limitation of such a time-lock system for a customer.

Accordingly, it is desired to develop a system and method which enables protecting data in such a way that it is not possible for any user with access to the storage services to modify the protected data, while still being able to modify the original data as necessary.

### SUMMARY

The present invention is directed toward a method for protecting data within a storage system. In various embodiments, the method includes the steps of receiving one or more user objects from a user into the storage system, each of the one or more user objects including user data that includes user metadata and raw data that are separated from one another by a storage manager; deduplicating the raw data with a data deduplicator; copying the user metadata and system metadata to provide copied metadata; and storing the copied metadata in a metadata storage area within the storage system so that the copied metadata stored in the metadata storage area is not modifiable by the user.

In some embodiments, the step of copying includes the metadata storage area being time-protected so that the copied metadata stored within the metadata storage area is not modifiable by the user for a specified period of time.

In certain embodiments, the method further includes the step of accessing the user data within the storage system during the specified period of time that the copied metadata stored within the metadata storage area is not modifiable by the user.

In some embodiments, the step of storing includes the copied metadata stored within the metadata storage area being modifiable by the user after expiration of the specified period of time.

In some embodiments, the method further includes the step of breaking up the one or more user objects into a plurality of sub-objects with the storage manager prior to deduplicating the user data with the data deduplicator.

In many embodiments, the step of copying includes the system metadata including details of the plurality of sub-objects.

In certain embodiments, the method further includes the step of storing the raw data in a data storage area within the storage system.

In many embodiments, the method further includes the step of storing the copied metadata in a separate, second metadata storage area within the storage system so that the copied metadata stored in the second metadata storage area is modifiable by the user.

In some embodiments, at least a portion of the copied metadata that is stored in the user modifiable, second metadata storage area and that is stored in the unmodifiable metadata storage area includes a reference that points to sub-objects in the data storage area that allows the system to rehydrate the raw data for the user objects.

The present invention is further directed toward a data protection system for protecting data within a storage system including one or more user objects from a user that are received into the storage system, each of the one or more user objects including user data that includes user metadata and raw data; a storage manager that separates the raw data from the user metadata; a data deduplicator that deduplicates the raw data; and a metadata storage area within the storage system that is configured to receive and store a copy of the user metadata and system metadata collectively as copied metadata so that the copied metadata stored in the metadata storage area is not modifiable by the user.

The present invention is also directed toward a method for protecting data within a storage system including the steps of receiving one or more user objects from a user into the storage system, each of the one or more user objects including user data that includes user metadata and raw data; breaking up the one or more user objects into a plurality of sub-objects with a storage manager; deduplicating the raw data with a data deduplicator after the one or more user object have been broken up into the plurality of sub-objects; storing the raw data in a data storage area within the storage system; copying the user metadata and system metadata to provide copied metadata; storing the copied metadata in a metadata storage area within the storage system so that the copied metadata stored in the metadata storage area is not modifiable by the user for a specified period of time; storing the copied metadata in a separate, second metadata storage area within the storage system so that the copied metadata stored in the second metadata storage area is modifiable by the user; and accessing the user data within the storage system during the specified period of time that the copied metadata stored within the metadata storage area is not modifiable by the user; wherein at least a portion of the copied metadata that is stored in the user modifiable, second metadata storage area and that is stored in the unmodifiable metadata storage area includes a reference that points to sub-objects in the data storage area that allows the system to rehydrate the raw data for the user objects.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified schematic illustration of a data storage system having features of the present invention, and which provides a foundation of existing technology upon which the present invention is built;

FIG. 2 is a simplified flowchart illustrating a method for development and use of a data protection system having features of the present invention for protecting data within a data storage system;

FIG. 3 is a simplified schematic illustration that shows user interaction with stored data within the data protection system illustrated in FIG. 2; and

FIG. 4 is a simplified schematic illustration that shows a set of copies of metadata usable within the data protection system illustrated in FIG. 2 which refers to the same data.

### DESCRIPTION

Embodiments of the present invention are described herein in the context of a system and method for protecting data in a back-up appliance using shallow metadata copying. More particularly, the present invention teaches a data protection system and method that enables protecting data within a data storage system in such a way that it is not possible for any user with access to the storage services to modify the protected data, while still being able to modify the original data as necessary. Thus, the functioning of the data storage system is greatly improved for purposes of data back-up and protection due to the data protection system that is incorporated into the general overall functionality of the data storage system.

Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same or similar reference indicators will be used throughout the drawings and the following detailed description to refer to the same or like parts.

In the interest of clarity, not all of the routine features of the implementations described herein are shown and described. It will, of course, be appreciated that in the development of any such actual implementations, numerous implementation-specific decisions must be made in order to achieve the developer's specific goals, such as compliance with application-related and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

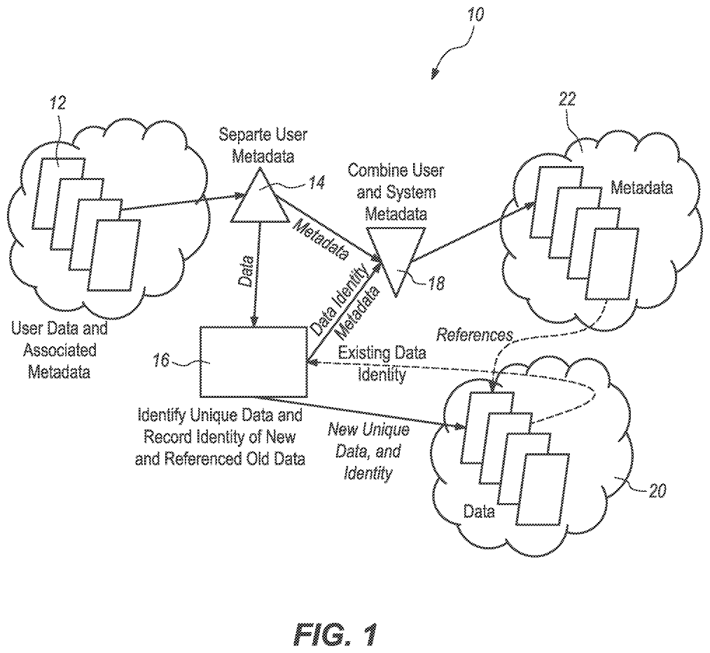

FIG. 1 is a simplified schematic illustration of a data storage system 10 (also sometimes referred to herein as a “storage system”) having features of the present invention, and which provides a foundation of existing technology upon which the present invention is built. As such, the storage system 10 is uniquely configured to perform the various tasks required for the data protection system to work.

In various embodiments, as illustrated, the storage system 10 can be configured to receive one or more user objects 12 that are provided in the form of user data that is comprised of raw data and associated user metadata. Subsequently, the user objects 12, and/or the user data, are sent to a storage manager 14 where the user objects 12, and/or the user data, are separated into the raw data and the associated user metadata. In certain embodiments, the storage manager 14 can include one or more processors or circuits that enable the storage manager 14 to effectively perform the functions described herein.

As shown, from the storage manager 14, the user data is moved to a data deduplicator 16 (sometimes referred to herein simply as a “deduplicator”). In certain embodiments, the deduplicator 16 is configured to analyze the user data to identify unique user data, and record identity of new and referenced old data.

Data identity metadata (or “system metadata”) is then moved to a metadata combiner 18 where the user metadata is combined with the system metadata.

As illustrated, the new unique user data and the associated identity is moved to and stored within a data storage area 20 (also sometimes referred to herein as a “data store”).

As shown, the combined user metadata and system metadata (also sometimes referred to simply as the “combined metadata”) is copied to provide copied metadata, which is subsequently moved to and stored within a metadata storage area 22 (also sometimes referred to herein as a “metadata store”). The combined metadata and/or copied metadata within the metadata store 22 further includes references to the user data and associated identity stored within the data store 20.

In some embodiments, the storage system 10 can present the metadata within the metadata store 22 to the user, to allow the user to browse and identify the objects they have stored, as well as information about them, such as name, size, and other attributes.

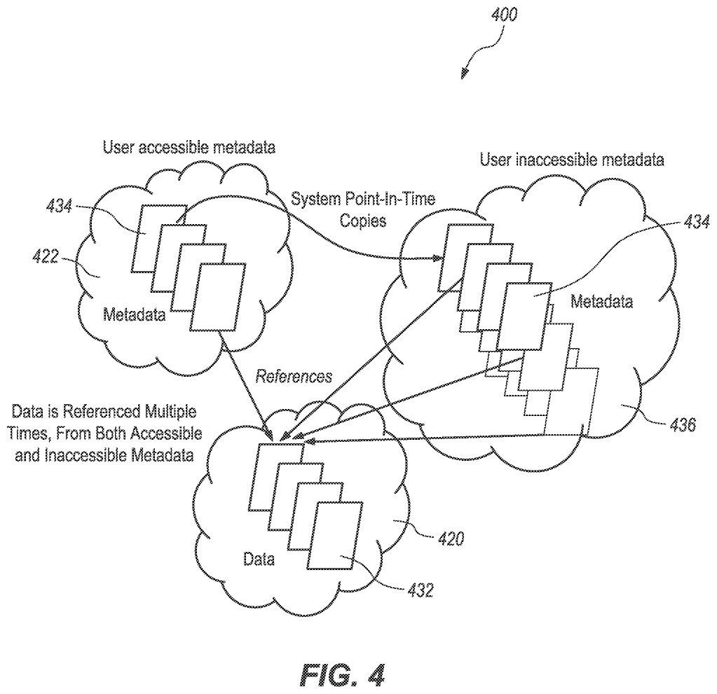

The user has access to the metadata store 22 to modify the metadata associated with their data. The user can also change the data that their objects refer to, but this creates new data in the data store 20, and does not modify the data previously associated with their objects. However, as described in detail herein below, the storage system 10 can be further modified to include a second metadata storage area 436 (or “second metadata store”, illustrated in FIG. 4) within which the copied metadata can be stored in a manner where the copied metadata is not accessible to the user, for at least a specified period of time.

In certain embodiments, sub-objects stored in the data store 20 cannot be accessed and/or modified by the user. Each sub-object is immutable, and can never change. A sub-object can only be deleted when all references to it (in the metadata store 22) are deleted. It is appreciated that references can be tracked by reference counting, by searching all the metadata, or some other method.

Thus, as can be seen, the unique user data is stored in the data store 20, while the combined metadata and/or copied metadata is stored in a logically separate metadata store 22 and a logically separate second metadata store 436. In various embodiments, the combined metadata consists of both the original metadata, and sufficient information and/or references to rehydrate the user's data from the data store 20. Thus, in various embodiments, the data storage system 10 has been modified from a conventional data storage system for improved functionality by adding new storage areas in the form of the metadata store 22 and the second metadata store 436, which are uniquely configured to store the deduplication metadata that is required for the data protection system to function as designed. As so described, this solution provides the technical benefit of leveraging the power of deduplication to rapidly create a snapshot of the user's data in such a way that requires only enough space to store metadata for the snapshot. This is a significant improvement over conventional data storage systems, which either require taking full copies of the source data into a protection area or making the source data read-only for a period. Accordingly, the data protection system and/or the data storage system 10 is able to protect data much better than in conventional systems, while still providing desired access to the underlying data, and while using far less resources overall. Thus, the technical solution incorporated within the present disclosure provides a method of making the data stored in the computer system more secure against an external attacker with read/write access to the regularly exported data. Moreover, it does so in a way which does not require a marked increase in space usage or time and in such a way that the user's normal use of their regularly exported data is unimpeded.

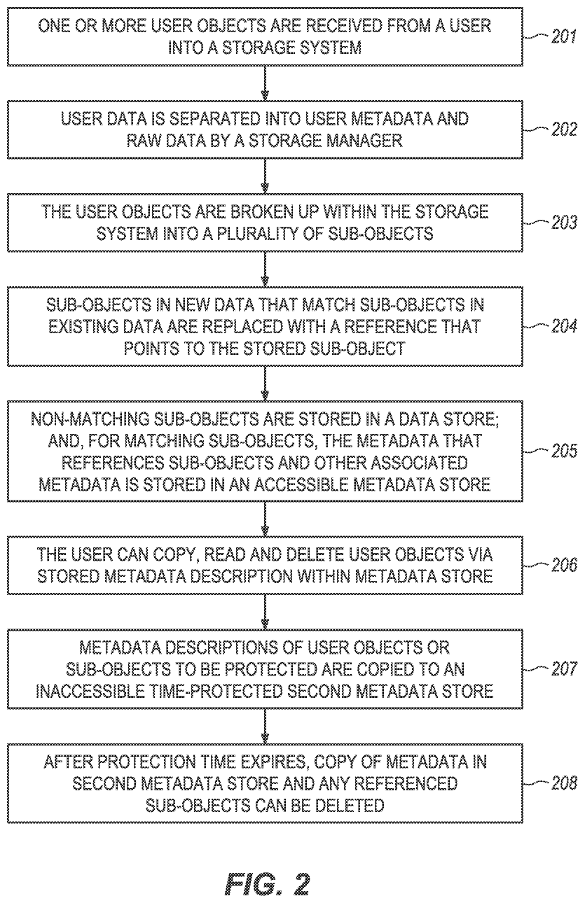

FIG. 2 is a simplified flowchart illustrating a method for development and use of a data protection system having features of the present invention for protecting data within a storage system. It is recognized that in nonexclusive alternative embodiments, the method can include additional steps other than those specifically delineated herein or can omit certain of the steps that are specifically delineated herein. Moreover, in some embodiments, the order of the steps described below can be modified and/or certain steps can be combined without deviating from the spirit of the present invention.

At step 201, one or more user objects are received from a user into the storage system. The user objects can be any suitable user objects that are generally provided in the form of user data. For example, in some non-exclusive implementations, the user objects and/or user data can be files, tape cartridges, or any other similar user objects.

At step 202, the user data is separated into user metadata (such as file name, VTL cartridge number, object identity, permissions, directory structure, and other attributes) and raw data (contents of the stored user objects), with the user metadata and the raw data being separated by a storage manager.

At step 203, the user objects are broken up into a plurality of sub-objects (also sometimes referred to as “chunks” or “blocklets”). It is appreciated that the user objects can be broken up into sub-objects of any suitable size and in any suitable manner. For example, one representative method for breaking up the user objects into sub-objects or chunks is described in U.S. Pat. No. 5,990,810, which, to the extent permissible, is incorporated in its entirety herein by reference. Alternatively, the user objects can be broken up into sub-objects in another suitable manner.

At step 204, references are added to the existing sub-objects that match portions of the object. Stated in another manner, the sub-objects in the newly received data that match sub-objects within the existing data are replaced with a small reference that points to the stored sub-object. Thus, with such methodology, there is no need to resave the data in whole. It is appreciated that this step of adding references should not be taken as a single potential implementation, but rather is generally included within all implementations.

At step 205, non-matching sub-objects are stored in a data storage area (or “data store”); and, for matching sub-objects, a description of the original user object (or sub-object) is stored as metadata in a first metadata storage area (or “metadata store”) that references old and new sub-objects, and any metadata already associated with the object by the user. It is appreciated that the first metadata store is user accessible. Stated in another manner, the specific combined metadata that is copied to and/or stored within the first metadata store is still accessible to the user while it is stored within the first metadata store.

At step 206, the user is able to copy, read, and delete their user objects or sub-objects via the combined metadata description of their user object within the first metadata store. Stated in another manner, the user is able to access and act on user objects or sub-objects by directly accessing the combined metadata within the first metadata store that references such user objects or sub-objects.

At step 207, to protect one or more user objects or sub-objects, the combined metadata descriptions of such user objects or sub-objects are copied to a time-protected second metadata storage area (also sometimes referred to as a “second metadata store” or the “protected store”) that is not user accessible. Stated in another manner, the specific combined metadata that is copied to and/or stored within the second metadata store is not accessible to the user while it is stored within the first metadata store.

In some embodiments, protection time is added to the copy of the existing combined metadata in the second metadata (or protected) store, such that the user does not have access to the combined metadata in the second metadata (protected) store to modify or delete such metadata for a specified length of the protection time. Copying of the combined metadata to the second metadata (protected) store also adds a reference to all of the sub-objects needed to rehydrate the user objects.

At step 208, after the expiry of the protection time, for a copy of the object in the protected metadata store, that copy of the combined metadata will be deleted. If any sub-objects are no longer referenced, they can also be deleted. It is appreciated that when a user deletes objects, the combined metadata description associated with those objects is removed, and any sub-objects that are no longer referenced by any other combined metadata descriptions of objects can also be deleted. However, it is further appreciated that deletion of objects and sub-objects may be deferred for efficiency reasons, and step 208 describes the time at which they logically can be deleted.

It is noted that the protection provided within the data protection system of the present invention is provided via the existence of the second copy of the combined metadata. More specifically, as described herein above, one or more user objects in a set can be copied, to create a second reference by just copying the associated combined metadata to a separate, second metadata store that is not user accessible. Creating a copy of the user objects is done by copying the combined metadata only, and does not require any full copying of the underlying user data or raw data. The user does not have access to the copied location within the second metadata store, except to restore a copy to the normal metadata location, so the system can set retention policies, and the data is safe from malicious or inadvertent destruction using the provided access mechanism.

In certain embodiments, the use of reference counting, or garbage collection, or some other technique to track what is referenced and allow performing the sub-object deletion is not necessarily relevant to the invention.

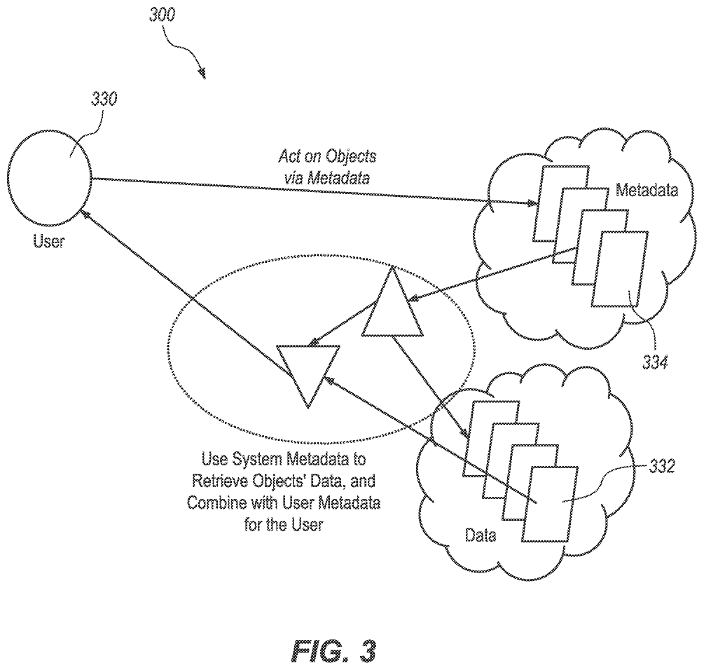

FIG. 3 and FIG. 4 are provided to show in further detail some of the processes and steps that are incorporated into the data protection system and method of the present invention.

FIG. 3 is a simplified schematic illustration that shows user interaction with stored data within the data protection system 300 illustrated in FIG. 2. In particular, FIG. 3 illustrates one representative implementation of how the user 330 can interact with existing data 332 and metadata 334.

As shown in FIG. 3, the user 330 can act on user objects by directly accessing the metadata 334 that references such user objects. The data protection system 300 and/or the storage system is then configured to use the system metadata 334 to retrieve the object's data 332, which is then combined with user metadata for the user 330. Thus, the user 330 is able to retrieve the data 332 via use of the metadata 334.

FIG. 4 is a simplified schematic illustration that shows a set of copies of metadata usable within the data protection system 400 illustrated in FIG. 2 which refers to the same data. It is appreciated that in various embodiments, the copied metadata 434 can include (i) user metadata that forms a portion of the user data along with the raw data, and (ii) system metadata that can include details relating to the plurality of sub-objects into which the user objects have been broken. Thus, as noted above, the copied metadata 434 can also be referred to as “combined metadata”.

In particular, FIG. 4 shows a first copy of the combined metadata 434, which is stored in a first metadata store 422, and which is accessible to the user 330 (illustrated in FIG. 3); and a second copy of the combined metadata 434, which is stored in a second metadata store 436, and which is inaccessible to the user 330.

It is appreciated that either metadata store 422, 436 can be referred to as the “first metadata store” and/or the “second metadata store”. Thus, there is no inventive significance to referring to either metadata store 422, 436 as the “first metadata store” and/or the “second metadata store”.

As shown in FIG. 4, the data protection system 400 is configured to make point-in-time copies of the combined metadata 434 saved in the first metadata store 422 (i.e. the accessible metadata) to generate the combined metadata 434 that is saved in the second metadata store 436 (i.e. the inaccessible metadata).

The data 432 saved in the data store 420 can then be referenced multiple times, from each of the accessible metadata and the inaccessible metadata.

As described in detail herein above, the present invention includes a data protection system and method that enables protecting data within a data storage system in such a way that it is not possible for any user with access to the storage services to modify the protected data, while still being able to modify the original data as necessary. Thus, the functioning of the data storage system is greatly improved for purposes of data back-up and protection due to the data protection system that is incorporated into the general overall functionality of the data storage system.

In summary, in various embodiments, the present invention requires a deduplicated storage solution. In this context deduplication works by utilizing a storage manager of the data storage system to separate user metadata (for example: file name, VTL cartridge number, object identity, permissions, directory structure, and other attributes) from raw data (contents of stored user objects, which could be files, tape cartridges, or any other similar user objects) from a set of user data that can be included within one or more user objects. The raw data is then broken into sub-objects using an appropriate algorithm, and identical sub-objects are not stored, or, if stored, are deleted once identified. In computing, data deduplication is a technique for eliminating duplicate copies of repeating data. Successful implementation of the technique can improve storage utilization, which may in turn lower capital expenditure by reducing the overall amount of storage media required to meet storage capacity needs. The deduplication process requires comparison of data “chunks” (also sometimes referred to as “sub-objects” or “blocklets”) of any suitable or desired size(s), which are unique, contiguous blocks of data.

These chunks are identified and stored during a process of analysis, and compared to other chunks within existing data. Whenever a match occurs between the compared data chunks, the redundant chunk is replaced with a small reference that points to the stored chunk, and there is no need to resave the data in whole. Given that the same chunk pattern may occur dozens, hundreds, or even thousands of times (with the match frequency being dependent on the chunk size), the amount of data that must be stored or transferred can be greatly reduced. Thus, storage-based data deduplication can effectively reduce the amount of storage needed for a given set of files.

Details of the sub-objects which make up the user data can be compiled as system metadata. The system metadata can then be combined with the user metadata to provide combined metadata.

As described, in various embodiments, the data protection system and/or the data storage system includes a new metadata storage area (protected storage area) has been added to the typical data storage system. The new storage area is configured to store the combined metadata (i.e. the user metadata and the system metadata) required for the data protection system to most effectively operate as designed. In some embodiments, additional software libraries may be added in order to facilitate collection and storage of the combined metadata into the protection area in a robust and secure way. In certain embodiments, a small number of control features can also be added to the user interface.

In many embodiments, the present invention includes taking a snapshot of the data at a given point in time, with the snapshot being a logical copy of all information at such point in time relating to a state of the data. In certain embodiments, the data protection system further provides an additional reference to the user's data that is retained in a user inaccessible area on the storage system, such as the new metadata storage area as noted in the preceding paragraph. By including such additional reference in the user inaccessible metadata storage area, the additional reference is prevented it from being removed when the original network accessible reference is deleted. This additional reference is time-protected and immutable until its specified retention period expires. In many implementations, the additional reference points to user data and/or sub-objects of the user data that are stored in a data storage area, and thus enables the data storage system to rehydrate raw data for the user objects.

It is appreciated that the snapshots/references are detached from the original metadata such that modifying or deleting the objects' data has no effect on the snapshot. There is no additional full copy of data made. If the original user objects are modified, the system creates new sub-objects to reflect the changed user data and updates the user-accessible system metadata. In such situations, the original sub-objects are not affected.

Within prior art storage systems, taking a copy of the data and making it not network accessible requires considerable additional storage capacity. However, with deduplicated storage such as incorporated into the present invention, the reference being stored only requires space for the combined metadata and/or copied metadata, until the original data is deleted, at which time the space is not freed, until the shadow copy expires. Thus, from a storage perspective this has the same impact as extending the retention of the original data by up to the time-protection period set for the shadow copy.

This approach is much faster than duplicating data onto additional storage. Since the snapshots are detached from the customer's live data, it allows the customer flexibility to modify and delete the live data as needed without it being locked, as in certain previous solutions (such as time-locks and WORM). The present operation is fast and requires minimal storage, so the user can schedule it at a frequency and retention length which provides the best balance of protection for their needs.

It is appreciated that the technique incorporated within the present invention can be useful for various purposes, such as ransomware protection and recovery. Additionally, the present technique can further be utilized to protect and retain data sets for any conceivable reason, such as complying with legislative retention requirements or litigation hold requests.

Thus, in various embodiments, the present invention includes technical features such as data deduplication, with the ability to separate data from metadata in the deduplication system; and a location to store metadata which is not exported or accessible to external clients.

Each technical feature is also configured to provide a particular technical benefit. For example, deduplication is required for the feature to work, for without deduplication the feature would necessarily resort to copying data or preventing the user from modifying their exported data. The ability to separate metadata from deduplicated data provides the ability to create a shallow metadata-only clone of the user's data. Without this, the storage system would need to resort to taking a full copy of the data. A secure location within the appliance is also required so that the protected combined metadata is not visible to the user in any way. If the combined metadata were externally visible, then it runs the risk of being modified or deleted by a malicious client.

It is understood that although a number of different embodiments of the storage system and/or the data protection system have been illustrated and described herein, one or more features of any one embodiment can be combined with one or more features of one or more of the other embodiments, provided that such combination satisfies the intent of the present invention.

While a number of exemplary aspects and embodiments of the storage system and/or the data protection system have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method for protecting data within a storage system, the method comprising the steps of:
receiving one or more user objects from a user into the storage system, each of the one or more user objects including user data that includes user metadata and raw data that are separated from one another by a storage manager;
deduplicating the raw data with a data deduplicator;
copying the user metadata and system metadata to provide copied metadata; and
storing the copied metadata in a metadata storage area within the storage system so that the copied metadata stored in the metadata storage area is not modifiable by the user.

2. The method of claim 1 wherein the step of storing includes the metadata storage area being time-protected so that the copied metadata stored within the metadata storage area is not modifiable by the user for a specified period of time.

3. The method of claim 2 further comprising the step of accessing the user data within the storage system during the specified period of time that the copied metadata stored within the metadata storage area is not modifiable by the user.

4. The method of claim 2 wherein the step of storing includes the copied metadata stored within the metadata storage area being modifiable by the user after expiration of the specified period of time.

5. The method of claim 1 further comprising the step of breaking up the one or more user objects into a plurality of sub-objects with the storage manager prior to deduplicating the user data with the data deduplicator.

6. The method of claim 5 wherein the step of copying includes the system metadata including details of the plurality of sub-objects.

7. The method of claim 1 further comprising the step of storing the raw data in a data storage area within the storage system.

8. The method of claim 7 further comprising the step of storing the copied metadata in a separate, second metadata storage area within the storage system so that the copied metadata stored in the second metadata storage area is modifiable by the user.

9. The method of claim 8 wherein at least a portion of the copied metadata that is stored in the user modifiable, second metadata storage area and that is stored in the unmodifiable metadata storage area includes a reference that points to sub-objects in the data storage area that allows the storage system to rehydrate the raw data for the user objects.

10. A data protection system for protecting data within a storage system, the data protection system comprising:
one or more user objects from a user that are received into the storage system, each of the one or more user objects including user data that includes user metadata and raw data;
a storage manager that separates the raw data from the user metadata;
a data deduplicator that deduplicates the raw data; and
a metadata storage area within the storage system that is configured to receive and store a copy of the user metadata and system metadata collectively as copied metadata so that the copied metadata stored in the metadata storage area is not modifiable by the user.

11. The data protection system of claim 10 wherein the metadata storage area is time-protected so that the copied metadata stored within the metadata storage area is not modifiable by the user for a specified period of time.

12. The data protection system of claim 11 wherein the user can access the user data within the storage system during the specified period of time that the copied metadata stored within the metadata storage area is not modifiable by the user.

13. The data protection system of claim 11 wherein the copied metadata stored within the metadata storage area is modifiable by the user after expiration of the specified period of time.

14. The data protection system of claim 10 wherein the one or more user objects are broken up into a plurality of sub-objects with the storage manager prior to being deduplicated by the data deduplicator.

15. The data protection system of claim 14 wherein the system metadata includes details of the plurality of sub-objects.

16. The data protection system of claim 10 wherein the raw data is stored in a data storage area within the storage system.

17. The data protection system of claim 16 wherein the metadata is further stored in a separate, second metadata storage area within the storage system so that the copied metadata stored in the second metadata storage area is modifiable by the user.

18. The data protection system of claim 17 wherein at least a portion of the copied metadata that is stored in the user modifiable, second metadata storage area and that is stored in the unmodifiable metadata storage area includes a reference that points to sub-objects in the data storage area that allows the storage system to rehydrate the raw data for the user objects.

19. A method for protecting data within a storage system, the method comprising the steps of:
receiving one or more user objects from a user into the storage system, each of the one or more user objects including user data that includes user metadata and raw data;
breaking up the one or more user objects into a plurality of sub-objects with a storage manager;
deduplicating the raw data with a data deduplicator after the one or more user object have been broken up into the plurality of sub-objects;
storing the raw data in a data storage area within the storage system;
copying the user metadata and system metadata to provide copied metadata;
storing the copied metadata in a metadata storage area within the storage system so that the copied metadata stored in the metadata storage area is not modifiable by the user for a specified period of time;
storing the copied metadata in a separate, second metadata storage area within the storage system so that the copied metadata stored in the second metadata storage area is modifiable by the user; and
accessing the user data within the storage system during the specified period of time that the copied metadata stored within the metadata storage area is not modifiable by the user;
wherein at least a portion of the copied metadata that is stored in the user modifiable, second metadata storage area and that is stored in the unmodifiable metadata storage area includes a reference that points to sub-objects in the data storage area that allows the storage system to rehydrate the raw data for the user objects.

20. The method of claim 19 wherein the step of storing includes the copied metadata stored within the metadata storage area being modifiable by the user after expiration of the specified period of time.
